(19) United States
(12) Patent Application Publication
(10) Pub. No.: US 2009/0003229 A1
(43) Pub. Date: Jan. 1, 2009

(54) Adaptive Bandwidth Management Systems And Methods

(76) Inventors: Kai Siang Loh, Singapore (SG); Bruce E. Lavigne, Roseville, CA (US); Vicente V. Cavanna, Roseville, CA (US); Koh Yew Thoon, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/772,171

(22) Filed: Jun. 30, 2007

(51) Int. Cl. H04L 12/24

(52) U.S. Cl. 370/252; 370/468

(57) ABSTRACT

Adaptive bandwidth management systems and methods are disclosed. An exemplary system comprises a network switching device including a plurality of physical ports and at least one switching fabric for managing connections between the physical ports. The system also includes a management processor operatively associated with the plurality of physical ports and the at least one switching fabric. The system also includes program code stored in computer-readable storage and executable by the management processor, the program code configuring the network switching device to conserve electrical energy based on the current bandwidth requirements.

### BACKGROUND

As network traffic increases, providing adequate bandwidth continues to be resource-intensive and inefficient. For example, more network switching devices (e.g., switches and routers) may be provided as a network grows to accommodate increasing network traffic. The switching capacity is typically based on peak hours of usage or anticipated network usage growth. However, using this approach there may be provided more network switching devices than are needed to effectively provide the required bandwidth during off-peak hours.

In addition, each of these network devices consumes electricity whether the network device is actively providing network services or simply waiting to provide network services. For example, when a computer or other device on the network goes into a hibernation mode or is logged off, the physical link is still established between the computer or other device and the network device, but little or no traffic is flowing to/from the device.

Fewer network switching devices may be provided than are necessary during peak hours of usage (e.g., based on average bandwidth requirements). However, this approach may result in bottlenecks during peak hours. Network switching devices may also be manually turned on/off on an as-needed basis. For example, some or all network switching devices may be powered off overnight and on weekends and holidays. However, this approach may result in some users being denied access to the network durum these times.

### BRIEF DESCRIPTION OF THE DRAWINGS

FIG. 1 is a high-level illustration of an exemplary networked computer system which may implement adaptive bandwidth management according to an embodiment.

FIG. 2 is a block diagram of an exemplary network switching device which may implement adaptive bandwidth management according to an embodiment.

FIG. 3 is a block diagram of another exemplary network switching device which may implement adaptive bandwidth management according to an embodiment.

FIG. 4 is a flow chart illustrating exemplary operations which may be implemented for adaptive bandwidth management according to an embodiment.

FIG. 5 is another flow chart illustrating exemplary operations which may be implemented for adaptive bandwidth management according to an embodiment.

### DETAILED DESCRIPTION

Adaptive bandwidth management systems and methods are disclosed. In exemplary embodiments, a network switching device may adaptively configure its bandwidth on an on-going basis in response to actual or expected demand for network resources (e.g., based on predicted network traffic conditions, network topology, time of day, and/or other factors). Although not limited in scope, such embodiments of adaptive bandwidth management are especially desirable to achieve better power efficiency in a network switch hardware architecture without manual intervention by reducing power consumption based on the network traffic.

### Exemplary Systems

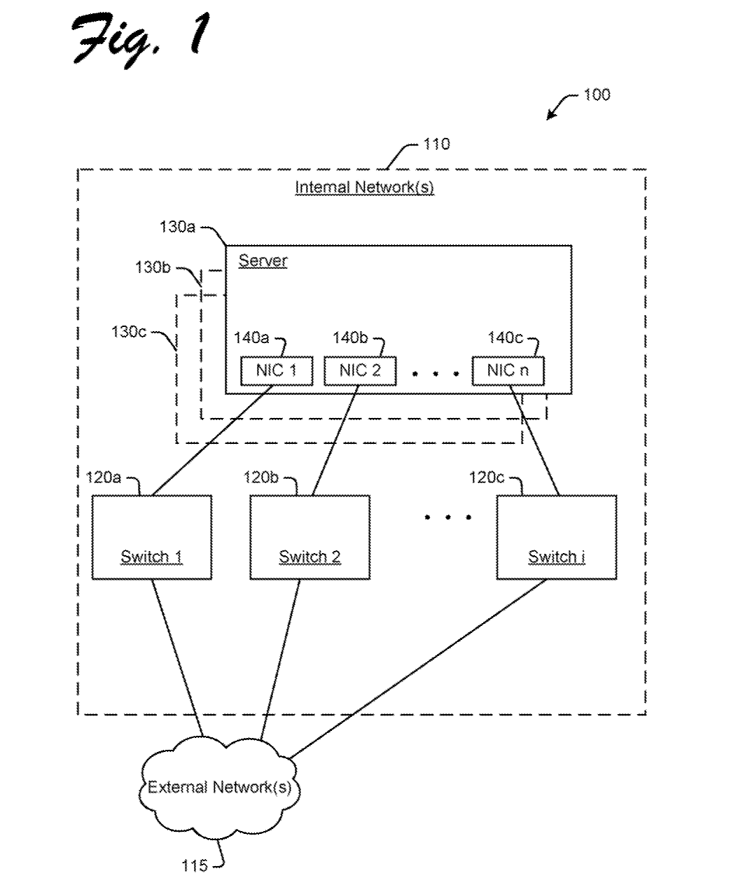

FIG. 1 is a high-level illustration of an exemplary networked computer system which may implement adaptive bandwidth management according to an embodiment. The computer network 100 may include one or more internal communication networks 110, such as a local area network (LAN), communicatively coupled to one or more external communication networks 115, such as a wide area network (WAN). One or more network switching devices 120a-c (e.g. Switch 1, Switch 2, . . . Switch i, referred to collectively as network switching devices 120) may be implemented to provide a communications link between host computing devices 130a-c (referred to collectively as hosts 130) and resources available in the internal network 110 and external network 115.

The term “network switching devices” 120 as used herein refers to a device for establishing, maintaining, and/or handling data communications in the computer network 100. Exemplary network switching devices may include, but are not limited to, Ethernet and Fibre Channel switches, routers, hubs, and any other device capable of enabling/disabling ports based on the contents of packets and limits exchanges to the links where such exchanges are needed (e.g., another server computer in a peer-to-peer network). It is noted that the network switching devices 120 include at least some form of computer-readable storage and at least some degree of processing capability to execute the program code described herein.

The term “host computing device” or “host” 130 as used herein refers to one or more computing systems, such as, e.g., server computers (or blade servers), personal computers (PCs), or other device with network access privileges. In an exemplary embodiment, the host 130 may include one or more network; interface cards (NICs) 140 (e.g., NIC 1, NIC 2, NIC 3, referred to collectively as NICs 140). Optionally, the host 130 may apply virtual NIC configurations by grouping Ethernet ports together and defining virtual interfaces to the grouping. This is achieved in an operating system (OS)-specific manner by each host OS. For example, the system administrator may load the configuration onto the host. Standard protocols for this purpose include SMASH/CLP and SMTP. Web-based management or a proprietary management interface would be equally appropriate.

During operation, there may be more network switching devices and/or available ports than are needed to effectively provide the required bandwidth. Accordingly, one or more of the network switching devices 120 may adaptively configure its bandwidth on an on-going basis in response to actual or expected demand for network resources, e.g., based on predicted network traffic conditions, network topology, time of day, and/or other factors.

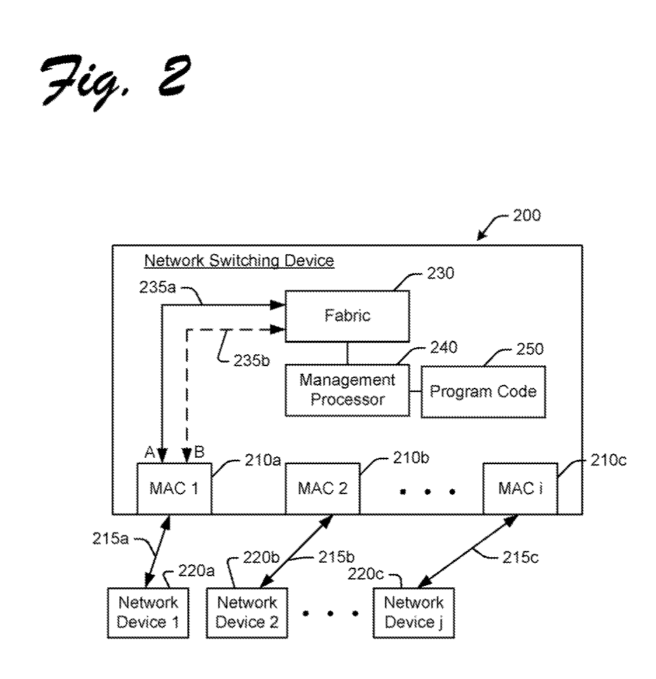

FIG. 2 is a block diagram of an exemplary network, switching device 200 (e.g., the network switching device 120 in FIG. 1) which may implement adaptive bandwidth management. The network switching device 200 may include one or more physical ports 210a-e (e.g., MAC 1, MAC 2, . . . MAC i) for connecting one or more network devices 220a-c via fabric 230 to one or more resources via the network.

The network devices 220a-c may be linked via physical link 215a-c to the physical ports 210a-e. Fabric 230 may be implemented to establish one or more logical connections to the network via high-speed serdes interfaces or “uplinks” 235a-b. For example, network device 220a may be connected to physical port 210a via physical link 215a, and then connected to the network via fabric 230 via either of the uplinks 235a or 235b. In an exemplary embodiment, a management processor 240 may execute program code 250 stored on computer-readable storage to adaptively manage bandwidth at the network switching device 200. Alternatively, this logic may exist as circuits in an Application Specific Integrated Circuit (ASIC) or Application Specific Standard Product (ASSP).

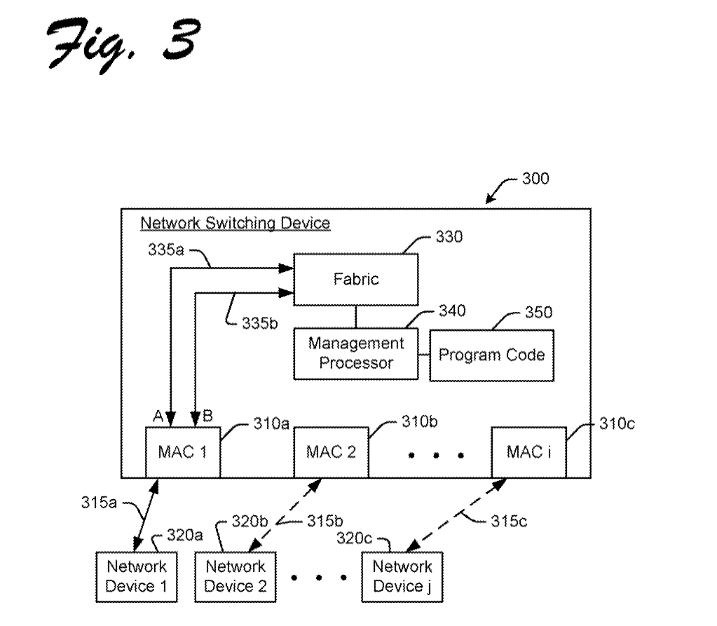

For purposes of illustration, all of the uplinks 235a-b may be implemented to satisfy bandwidth requirements when many of the network devices 220a-c are accessing the network (e.g., during peak hours). However, the management processor 240 may execute program code 250 to de-allocate one or more of the uplinks (e.g., uplink 235b indicated in FIG. 3 by dashed lines) when bandwidth requirements can be satisfied without needing all of the uplinks 235a-b.

It is noted that, the bandwidth requirements may be determined based on any of a number of factors. For example, the management processor 240 may execute program code 250 to monitor network traffic (e.g., counting packets) and determine bandwidth requirements. Or for example, bandwidth requirements may be based on user/administrator input values (e.g., peak hours of operation, physical location, etc.), or a combination of all these factors. Additionally, the program code or logic may use a hysterisis function to enable links quickly when bandwidth demand grows, but de-allocate them much more slowly, in case another bandwidth spike were to occur shortly after a lapse. For example, a de-allocated link may be powered up immediately when demand exceeds 80% of the currently active links, but links may be de-allocated only when demand has fallen below 40% for a user-configured time, perhaps 5 minutes.

According to such an embodiment, redundant links may be shut down or powered off when not needed, but powered on again when needed or “on-demand.” As the overall number of uplinks in a given network is usually very high, such an embodiment results in substantial power savings and an environmentally friendly or so-called “green” network.

FIG. 3 is a block diagram of another exemplary network switching device 300 (e.g., the network switching device 120 in FIG. 1) which may implement adaptive bandwidth management according to an embodiment. The network switching device 300 may include one or more physical ports 310a-c (e.g., MAC 1, MAC 2, . . . MAC i) for connecting one or more network devices 320a-c via fabric 330 to one or more resources via the network.

Again, the network devices 320a-c may be linked via physical link 315a-c to the physical ports 310a-c. Fabric 330 may be implemented to establish one or more logical connections to the network via uplinks 335a-b. For example, network device 310a may be connected to physical port 310a via physical link 315a, and then connected to the network via fabric 330 via either of the uplinks 335a or 335b, In an exemplary embodiment, a management processor 340 may execute program code 350 stored on computer-readable storage to adaptively manage bandwidth at the network switching device 300.

For purposes of illustration, physical links 315a-c may be implemented to satisfy bandwidth requirements when all of the network devices 320a-c are accessing the network. However, the management processor 340 may execute program code 350 to de-allocate one or more of the physical links 315a-c when the corresponding network device 320a-c is no longer actively accessing the network. For example, physical links 315b and 315c may be de-allocated or shut off when network devices 320a and 320c, respectively, go offline or are otherwise no longer actively accessing the network (e.g., in hibernation or sleep mode), as indicated in FIG. 3 by dashed lines.

It is noted that the bandwidth requirements may be monitored by a “watchdog” (e.g., program code executable by the management processor). In operation, the watchdog may “listen” to ports and determine a level of traffic activity. When a network device connected to the network switch 300 goes into hibernation mode or gets logged off, the traffic activity for that port drops to zero. The watchdog senses this drop, and a timer may be started (e.g., implemented in the program code). When a predetermined time is reached, the management processor sets the port from normal mode to low-power mode (or turns it off completely). The watchdog continues to monitor the port 310 for activity, and re-allocates the port 310 when activity is detected.

It is noted that the exemplary network switching devices described above with reference to FIGS. 2 and 3 are not intended to be limiting. For example, the functionality of either or both network switching devices may be combined into a single network switching device and need not be provided as separate entities. Additional functionality may also be provided, as will be understood by those having ordinary skill in the art after becoming familiar with, the teachings herein.

### Exemplary Operations

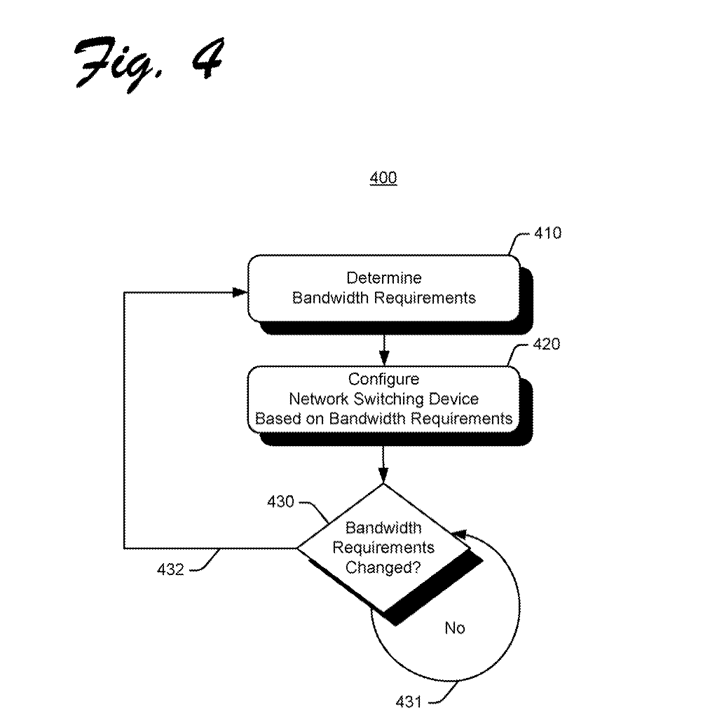

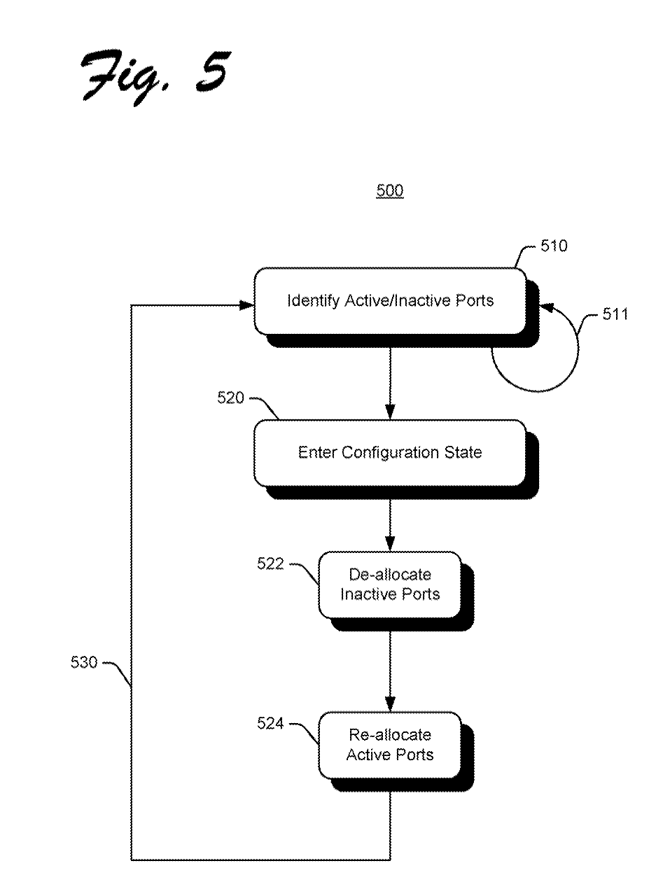

FIGS. 4 and 5 are flow charts illustrating exemplary operations which may be implemented for adaptive bandwidth management according to an embodiment. The methods and operations described may be embodied as logic instructions (i.e., program code implemented in firmware and/or software) stored on one or more computer-readable medium or as logic cells, for example in an Application Specific Integrated Circuit (ASIC) or Application Specific Standard Product (ASSP). When executed on a processor, the logic instructions cause a general purpose computing device to be programmed as a special-purpose machine that implements the described methods and/or operations.

FIG. 4 is a flow chart illustrating exemplary operations 400 which may be implemented for adaptive bandwidth management according to an embodiment. In operation 410 the bandwidth requirements are determined. For example, the bandwidth requirements may be based on time-of-day, monitored network traffic, and/or other considerations. In operation 420, the network switching device is configured based on bandwidth requirements. For example, if additional bandwidth is needed to support actual or expected network traffic (e.g., during peak hours), then additional ports may be allocated for use by the network switching device. Or if less bandwidth is needed to support actual or expected network traffic (e.g., during off-peak hours), then one or more ports may be de-allocated for use by the network switching device. In operation 430, a determination is made whether the bandwidth requirements have changed. If bandwidth requirements have not changed, operations continue to loop 431 at operation 430 until bandwidth requirements have changed, and then return 432 to operation 410.

FIG. 5 is another flow chart illustrating exemplary operations 500 which may be implemented for adaptive bandwidth management according to an embodiment. In operation 510 active/inactive ports are identified on the network switching device. For example, a discovery frame may be issued, and an active connection is indicated if an acknowledgment is received. If all ports are active, operations continue to loop 511 at operation 510 until inactive ports are identified. In operation 520, the network switching device enters a configuration state. In operation 522 of the configuration state, inactive ports may be de-allocated. In operation 524 of the configuration state, previously de-allocated ports may be re-allocated. Operations then return 530 to operation 510 to continue identifying active/inactive ports on the network switching device.

Other embodiments are also contemplated and are not limited to the operations and/or ordering of the operations illustrated by FIGS. 4 and 5. Other operations and modifications to these operations will be readily apparent to those having ordinary skill in the art after becoming familiar with the teachings herein.

The exemplary embodiments shown and described are provided for purposes of illustration and are not intended to be limiting. Still other embodiments are also contemplated.

1. A method for adaptive bandwidth management, comprising:
determining current bandwidth requirements at a network switching device; and
configuring the network switching device to conserve electrical energy based on the current bandwidth requirements.

2. The method of claim 1, further comprising:
issuing a discovery frame to a device connected to at least one physical port of the network switching device;
maintaining a current port configuration for the at least one physical port on the network switching device if an acknowledgement is received.

3. The method of claim 2, further comprising de-allocating the at least one physical port on the network switching device if no acknowledgement is received.

4. The method of claim 3, further comprising re-allocating the at least one physical port on the network switching device on-demand.

5. The method of claim 1, wherein determining the current bandwidth requirements is based on actual demand for network resources.

6. The method of claim 5, wherein expected demand for network resources is based at least in part on monitored network traffic.

7. The method of claim 1, wherein determining the current bandwidth requirements is based on expected demand for network resources.

8. The method of claim 7, wherein expected demand for network resources is based at least in part on network topology.

9. The method of claim 7, wherein expected demand for network resources is based at least in part on time of day.

10. A system for adaptive bandwidth management, comprising:
a network switching device including a plurality of physical ports and at least one switching fabric for managing connections between the physical ports;
a management processor operatively associated with the plurality of physical ports and the at least one switching fabric; and
program code stored in computer-readable storage and executable by the management processor, the program code configuring the network switching device to conserve electrical energy based on the current bandwidth requirements.

11. The system of claim 10, wherein the management processor executes the program code to monitor physical port usage by issuing discovery frames to one or more devices connected to the physical ports.

12. The system of claim 11, wherein a current port configuration for the physical ports is maintained if an acknowledgement to the discovery frame is received.

13. The system of claim 11, wherein the management processor executes the program code to de-allocate at least one physical port on the network switching device if no acknowledgement to the discovery frame is received.

14. The system of claim 13, wherein the management processor executes the program code to re-allocate the at least one physical port on the network switching device on-demand.

15. The system of claim 10, wherein the management processor executes the program code to determine the current bandwidth requirements based on actual demand for network resources.

16. The system of claim 10, wherein the management processor executes the program code to determine the current bandwidth requirements based on expected demand for network resources.

17. The system of claim 10, wherein the management processor executes the program code to determine the current bandwidth requirements based on at least one of the following: monitored network traffic, network topology, and time-of-day.

18. A system for adaptive bandwidth management, comprising:
means for managing network connections;
means for determining current bandwidth requirements; and
means for configuring the network switching device to conserve electrical energy based on the current bandwidth requirements.

19. The system of claim 18, wherein the means for determining the current bandwidth requirements uses actual demand data for network resources.

20. The system of claim 18, wherein the means for determining the current bandwidth requirements uses expected demand data for network resources.
